(19) United States
(12) Patent Application Publication
(10) Pub. No.: US 2025/0360901 A1
(43) Pub. Date: Nov. 27, 2025

(54) BRAKE SYSTEM AND METHOD FOR CONTROLLING A BRAKE SYSTEM

(71) Applicant: Continental Automotive Technologies GmbH, Hannover (DE)

(72) Inventors: Thorsten Ullrich, Gernsheim (DE); Martin Baechle, Königstein (DE)

(73) Assignee: Continental Automotive Technologies GmbH, Hannover (DE)

(21) Appl. No.: 19/218,235

(22) Filed: May 24, 2025

(30) Foreign Application Priority Data
May 24, 2024 (DE) 10 2024 204 798.8
Sep. 26, 2024 (DE) 10 2024 209 341.6

(51) Int. Cl. B60T 13/74; B60T 7/04; B60T 17/22

(52) U.S. Cl. CPC B60T 13/741; B60T 7/042; B60T 17/221; B60T 2270/413; B60T 2270/82

(57) ABSTRACT

A brake system for a motor vehicle comprising a brake pedal having at least one pedal sensor for capturing a driver brake request using pedal sensor data. The brake system has four electromechanical wheel brakes, two brake control units, and a vehicle regulator. The brake control unit calculates preprocessing data from the pedal sensor data and makes the data available to the vehicle regulator via a signal connection. The vehicle regulator calculates control information for the wheel based on the preprocessing data. The brake system comprises two primary wheel brake modules which are each arranged on a vehicle wheel and in each case one of the electromechanical wheel brakes and one assigned brake control unit are integrated. The pedal sensor is connected to both brake control units via in each case one separate brake request signal line. A control method for such a brake system is also disclosed.

### TECHNICAL FIELD

The embodiments relate to a brake system, in particular for a motor vehicle, and to a control method for such a brake system.

### BACKGROUND

Such a brake system is known from DE 10 2022 209 930 A1.

EMB system architectures (EMB=electromechanical brake) are known from the subsequently published German patent application with file reference 10 2023 200 166.7 and make it possible to implement a two-circuit fallback level. The basic prerequisite here is the use of a redundant electronic brake pedal, in which the two independent sensor paths are supplied to two likewise independent electronic control units. Said patent application proposes two axle control units (AxCU, that is to say control units for regulating the electromechanical wheel brakes of a vehicle axle) for processing the redundant sensor paths. These two control units process the sensor signals from the electronic brake pedal, for example by reading in sensor interfaces according to the SENT standard, carry out preprocessing, monitoring and possibly plausibility checking and provide the signals conditioned in this manner on the communication bus(es). Thus, the information about the degree of actuation of the brake pedal reaches a vehicle regulator which again calculates the brake request therefrom in the form of a brake force or a vehicle deceleration, distributes the brake forces to the four wheel brakes of the vehicle and sends corresponding target values to the control units of the electromechanical wheel brakes.

For the complete failure of the vehicle regulator, at least one redundancy level is required for calculating and implementing the driver brake request. This already results from the relevant standards which prescribe a minimum deceleration capability in the event of a single fault of the brake system.

### SUMMARY

The embodiments are therefore based on the object of further increasing the failure safety of the brake system, for example in the event of disturbances/faults in the vehicle regulator which are not detected otherwise. This relates for example to those cases in which the vehicle regulator does not fail completely, e.g. can still supply control information, but this is potentially erroneous. This may be caused by both hardware faults and software errors. Such partial functional failures are more challenging to detect than complete failures and are therefore not covered or only partially covered by previous safety measures and fallback levels.

Accordingly, a brake system of the type mentioned at the outset wherein the brake system comprises at least two primary wheel brake modules which are designed for arrangement on in each case one vehicle wheel and in which in each case one of the electromechanical wheel brakes and in each case one assigned brake control unit are integrated, wherein the pedal sensor is connected to both brake control units via in each case one separate brake request signal line. This configuration makes it possible to achieve higher failure safety since the at least one pedal sensor is connected to two brake control units via brake request signal lines which are independent of one another. The integration of in each case one of the electromechanical wheel brakes and in each case one assigned brake control unit in a primary wheel brake module reduces the installation outlay in comparison with separate redundant brake control units with nevertheless high failure safety of the brake system.

The terms signal line and signal connection are used synonymously in this document.

In one embodiment, the brake pedal comprises at least two pedal sensors which determine different measurement variables, for example a force sensor and/or a travel sensor and/or an angle sensor, and wherein at least the signals from two pedal sensors, which determine different measurement variables, can be transmitted to each of the brake control units during operation. The use of pedal sensors which determine different measurement variables increases the failure safety and, depending on the combination of the measurement data, also in part the accuracy of the brake request capture.

The brake pedal may comprise at least two redundant pedal sensors which determine the same measurement variable, for example two force sensors and/or two travel sensors and/or two angle sensors, and wherein signals from in each case one redundant pedal sensor can be transmitted to in each case one brake control unit during operation. The pedal sensors which determine the same measurement variable are pedal sensors with a different design and/or different measurement principle for the same measurement variable. The brake pedal may comprise at least four pedal sensors, wherein at least in each case two pedal sensors each determine the same measurement variable, that is to say for example two force sensors and two travel sensors. Alternatively, it is also possible to use in each case two pedal sensors which determine three different measurement variables, that is to say for example two force sensors, two travel sensors and two angle sensors. The signals from two (or three) pedal sensors, which determine different measurement variables, can then be transmitted to each brake control unit during operation by different pedal sensors. Each brake control unit is then assigned its own set of pedal sensors which determine different measurement variables. Each of the features mentioned increases the failure safety of the brake system.

In one embodiment, the two primary wheel brake modules are assigned to one axle of the vehicle, and at least one basic control unit is assigned to the two other electromechanical wheel brakes on the other axle of the vehicle and is designed to receive control information and to control at least one of the other electromechanical wheel brakes. The basic control unit(s) may not configured to calculate preprocessing data from the pedal sensor data. The basic control units can thus be simpler control units than the brake control units.

At least one basic control unit can be supplied with control information by both brake control units via separate signal lines during operation. As a result, during normal operation, the brake control units can be connected in the signal path between the vehicle regulator and the basic control units, such that the brake control units can assume monitoring functions via the vehicle regulator. In this way, incorrect control information can be identified by the brake control units before it is implemented.

The brake system may comprise two secondary wheel brake modules which are designed for arrangement on in each case one vehicle wheel and in which in each case one of the other electromechanical wheel brakes and in each case one assigned basic control unit are integrated, wherein each of the basic control units is designed to receive control information and to control the assigned electromechanical wheel brake. A wheel brake module comprising an electromechanical wheel brake and a wheel control unit (WCU) is then arranged on each of the vehicle wheels, which increases the failure safety of the brake system without significantly increasing the installation outlay.

Both basic control units can be supplied with control information by both brake control units via separate signal lines during operation. As a result, in the event of failure of one of the signal lines, the brake control unit connected to the other signal line can send control information to the two basic control units (and optionally the other brake control unit or its assigned wheel brake).

The vehicle regulator may be configured to transmit the control information for all four electromechanical wheel brakes to the brake control units via a signal line, e.g. via two separate signal lines, wherein the brake control units are each configured to forward the control information to the four electromechanical wheel brakes. As a result of this type of signal distribution of the control information, at least one brake control unit can check the control information from the vehicle regulator for all four wheel brakes before it is implemented. This makes it possible to detect faults, software errors and partial failures of the vehicle regulator, which could otherwise lead to a faulty braking process. Previous safety measures and fallback levels are generally focused on more easily automatically detectable total failures of hardware, but, as a result of the increasing software control of the vehicles, safety measures with respect to software faults are becoming more and more important.

In one embodiment, at least one brake control unit is configured to check the control information for the electromechanical wheel brakes that is received from the vehicle regulator before forwarding and to overwrite it when a safety threshold is undershot. This makes it possible to avoid, for example, safety-relevant underbraking caused by incorrect control information from the vehicle regulator.

The object according is furthermore achieved by a method for controlling a brake system comprising the steps of:
transmitting pedal sensor data, which are indicative of a pedal actuation of a brake pedal, to at least one of the brake control units,
calculating preprocessing data by means of at least one of the brake control units, transmitting the preprocessing data by means of at least one of the brake control units to the vehicle regulator via a signal connection,
calculating control information for four electromechanical wheel brakes from the preprocessing data in the vehicle regulator,
transmitting the control information for all electromechanical wheel brakes to at least one brake control unit,
determining, by means of at least one brake control unit, before forwarding to the electromechanical wheel brakes, whether the control information received from the vehicle regulator undershoots a safety threshold, and if so, overwriting the control information before forwarding to the electromechanical wheel brakes. This makes it possible to avoid, for example, safety-relevant underbraking caused by incorrect control information from the vehicle regulator. At the same time, the detailed braking behavior during normal operation can be adapted by the vehicle regulator of the respective automobile manufacturer and the brake control units overwrite the control information, for example, only when safety-relevant underbraking is detected. As a result of the sequence of signal forwarding and processing, the at least one brake control unit knows the pedal sensor data and can therefore detect, as a result of the comparison of the pedal sensor data or the preprocessing data with the control information, if a safety-relevant error has occurred in the calculation of the control information in the vehicle regulator.

The safety threshold may be defined by a characteristic curve which is dependent on the pedal sensor data, wherein the characteristic curve is stored locally in the at least one brake control unit. The characteristic curve can be stored, for example, as a lookup table or as a functional dependence in the respective (or in both) brake control unit(s).

In one embodiment, the brake control units automatically calculate secondary control information from the pedal sensor data and use it to overwrite the control information received from the vehicle regulator if the safety threshold is undershot. Thus, the brake control units can react more quickly if the control information from the vehicle regulator undershoots the safety threshold, since the secondary control information has already been calculated in parallel with the vehicle regulator and is present without requiring further local calculation steps.

The step of determining whether the control information received from the vehicle regulator undershoots a safety threshold is carried out by both brake control units. All the steps of the method that are relevant to the brake control unit may be carried out in parallel in both brake control units, but only one of the brake control units transmits the control information to the wheel brakes at the end of the method. As a result, it is possible for the brake control units to check the plausibility of the preprocessing data and/or the control information with one another and, in the event of failure of one of the brake control units, for the other to take over at any time.

In one embodiment, the safety threshold is determined on the basis of a pedal-sensor-data-dependent deceleration characteristic curve, for example pedal-force-dependent. The safety threshold is below the deceleration characteristic curve by a constant deceleration value, for example between 0.4 and 0.8 standard acceleration of gravity, wherein the safety threshold however is always at least 0 m/s². This ensures that the brake control unit does not intervene and the control information is not overwritten in the case of relatively small deviations of the control information sent from the vehicle regulator to the brake control unit(s) from the deceleration characteristic curve. At the same time, however, it is ensured that the brake control unit intervenes when a brake request has been detected from the pedal sensor data, but the vehicle regulator does not implement any deceleration at all in the control information (for example on account of a software or memory error).

The overwriting of the control information when the safety threshold is undershot once is carried out until one of new control information from the vehicle regulator is again above the safety threshold, or the end of the current braking process is determined or the start of a new braking process is determined, or the end of the current driving cycle of the vehicle is determined or the start of a new driving cycle of the vehicle is determined.

Overwriting of the control information before forwarding to the electromechanical wheel brakes takes place only if the control information received from the vehicle regulator permanently undershoots the safety threshold for a predetermined minimum duration, for example 25-250 milliseconds. Suitably selecting the minimum duration makes it possible to reduce the probability of unwanted erroneous activation of the “overwrite mode”, since, for example, the brake control unit does not take over on account of a single excessively low value of the control information from the vehicle regulator. At the same time, the minimum duration should not be selected to be too high in order to ensure sufficiently rapid intervention of the brake control unit in the event of emergency braking and simultaneous partial failure of the vehicle regulator.

### BRIEF DESCRIPTION OF THE DRAWINGS

Further details are clear from the description of the illustrated exemplary embodiments and the attached claims. In the drawings:

FIGS. 1 and 2 show brake systems having a basic control unit,

FIGS. 3 and 4 show brake systems having two secondary wheel brake modules,

FIG. 5 shows a flowchart of a method, and

FIG. 6 shows a possible characteristic curve which is dependent on the pedal sensor data.

### DETAILED DESCRIPTION

In the detailed description of embodiments below, the same reference signs denote substantially the same or identical parts in or on these embodiments. However, for better clarification, the embodiments shown in the figures are not always shown to scale.

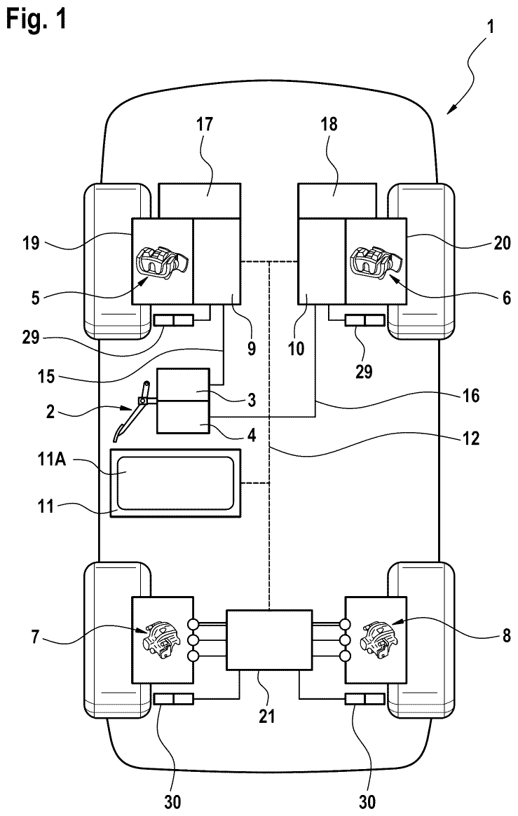

FIGS. 1 to 4 show embodiments of brake systems 1 for a motor vehicle, comprising a brake pedal 2 having at least two pedal sensors 3, 4 for capturing a driver brake request by means of pedal sensor data. Furthermore, the brake system 1 comprises four electromechanical wheel brakes 5, 6, 7, 8 and two brake control units 9, 10.

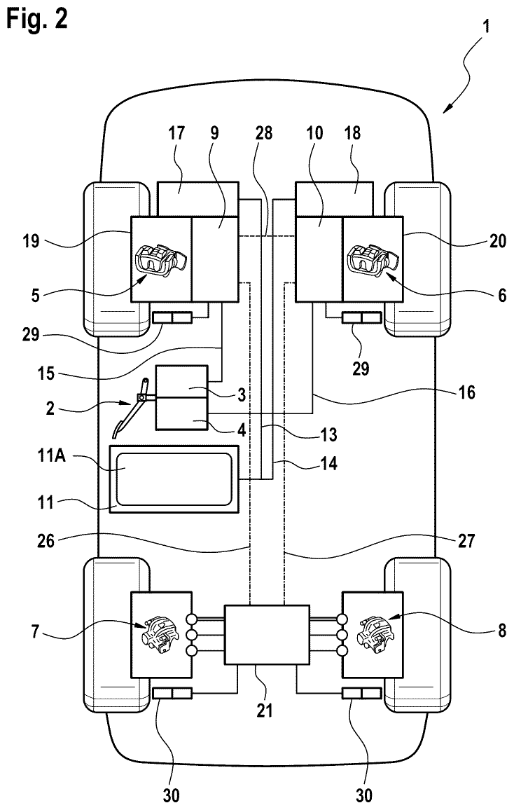

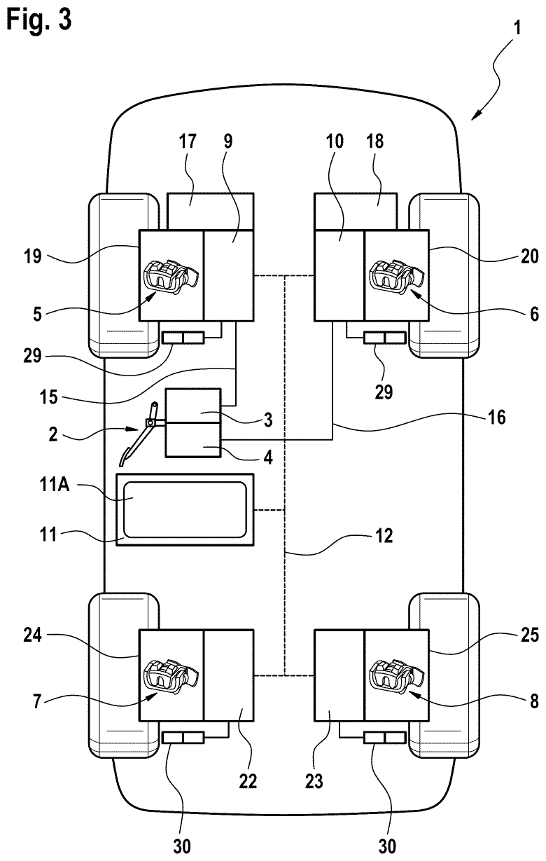

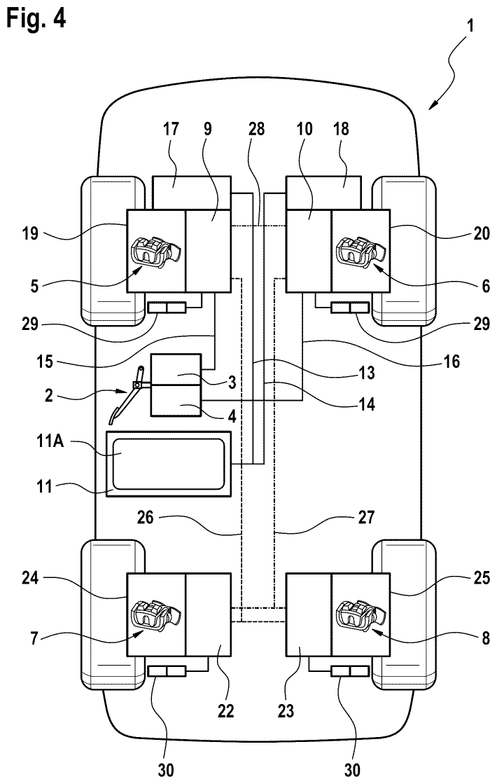

Each brake control unit 9, 10 is configured to calculate preprocessing data from the pedal sensor data and to make them available to a vehicle regulator 11 via a signal connection 12, 13, 14. The signal connection 12 may be a vehicle bus (e.g. CAN bus) (see FIGS. 1 and 3) or the signal connections 13, 14 between the vehicle regulator 11 and the brake control units 9, 10 may be separate signal lines (see FIGS. 2, 4). The vehicle regulator 11 can be configured, inter alia, to perform vehicle chassis functions 11A (such as control functions for the brake system 1), wherein this may carried out by means of correspondingly configured software.

The pedal sensors 3, 4 are connected to both brake control units 9, 10 via in each case one separate brake request signal line 15, 16.

The vehicle regulator 11 is configured to calculate control information for all electromechanical wheel brakes 5, 6, 7, 8 on the basis of the preprocessing data and to transmit said control information to the wheel brakes via at least one signal connection 12, 13, 14. The brake control units 9, 10 are assigned in each case to one brake circuit 17, 18 and, in the event of failure of the vehicle regulator 11 and/or of the respective other brake control unit 9, 10, can independently supply all electromechanical wheel brakes 5, 6, 7, 8 with control information.

Each of the brake control units 9, 10 is configured to forward control information (from the vehicle regulator 11 or its own in the fallback level) to the four electromechanical wheel brakes 5, 6, 7, 8.

The brake system architecture proposed is therefore suitable for implementing a dual-circuit fallback level (via the brake circuits 17, 18). This should be understood as meaning that both brake control units 9, 10, which process the sensor data from the electronic brake pedal 2, not only have sensor signal preprocessing but their own capture of the brake request and can also perform a (generally conservative, i.e. stable) brake force distribution. There is thus a double-redundant path for controlling the electromechanical wheel brakes 5, 6, 7, 8. These redundant paths can be brought into effect in the event of detected faults, for example the failure of the vehicle regulator 11, of a vehicle electrical system or of one of the brake control units 9, 10 of the electromechanical wheel brakes 5, 6, 7, 8.

It is proposed to connect the redundant sensor paths, for example via the separate brake request signal lines 15, 16, of the electronic brake pedal 2 to the two independent brake control units 9, 10 of the electromechanical wheel brakes 5, 6, 7, 8, of an axle, for example of the front axle. A connection of the brake pedal 2 to wheel control units of the electromechanical wheel brakes 7, 8 of the rear axle is not shown, but is likewise possible.

A diagonal distribution, i.e. the connection of one of the two redundant sensor paths of the electronic brake pedal 2 to a brake control unit of the front axle and of the other sensor path to a brake control unit of the rear axle, would likewise be possible. However, the connection to the brake control units 9, 10 of the electromechanical wheel brakes 5, 6 of the front axles may be to keep the line lengths for the connection of the sensor paths of the electronic brake pedal 2 as short as possible.

In all embodiments, provision is made for the two brake control units 9, 10, which are used to connect the redundant sensor paths, to be supplied by different (independent) vehicle electrical systems.

Accordingly, the brake system 1 comprises two primary wheel brake modules 19, 20 which are designed for arrangement on in each case one vehicle wheel and in which in each case one of the electromechanical wheel brakes 5, 6 and in each case one assigned brake control unit 9, 10 are integrated. The two primary wheel brake modules 19, 20 are assigned to one axle of the vehicle. At least one basic control unit 21, 22, 23 is assigned to the two other electromechanical wheel brakes 7, 8 on the other axle of the vehicle and is designed to receive control information and to control at least one of the other electromechanical wheel brakes 7, 8.

It is possible to provide a basic control unit 21 for two electromechanical wheel brakes 7, 8 of the same axle of the vehicle (FIGS. 1, 2). However, it is also possible for a separate basic control unit 22, 23 to be provided for each of the electromechanical wheel brakes 7, 8 (see FIGS. 3, 4).

In the embodiments in FIGS. 3, 4, the brake system comprises two secondary wheel brake modules 24, 25 which are designed for arrangement on in each case one vehicle wheel and in which in each case one of the other electromechanical wheel brakes 7, 8 and in each case one assigned basic control unit 22, 23 are integrated.

Each basic control unit 21, 22, 23 can be supplied with control information by both brake control units 9, 10 via at least one signal line 12, 26, 27 during operation. This signal line 12 can be a system bus, as in FIGS. 1, 3, or in each case a separate signal line 26, 27 can be provided from each of the brake control units 9, 10 to in each case both basic control units 22, 23, as in FIGS. 2, 4.

The primary wheel brake modules 19, 20 or the brake control units 9, 10 are either connected via a signal connection 12 in the form of a system bus, as in FIGS. 1, 3 for example, or they are provided via a separate signal connection 28, as in FIGS. 2, 4 for example.

A respective rotational speed sensor 29 of the associated vehicle wheel is connected to each brake control unit 9, 10 in order to provide rotational speed data. One (FIGS. 1, 2) or two (FIGS. 3, 4) rotational speed sensor(s) 30 of the associated vehicle wheel or wheels is/are connected to each basic control unit 21, 22, 23 in order to provide rotational speed data.

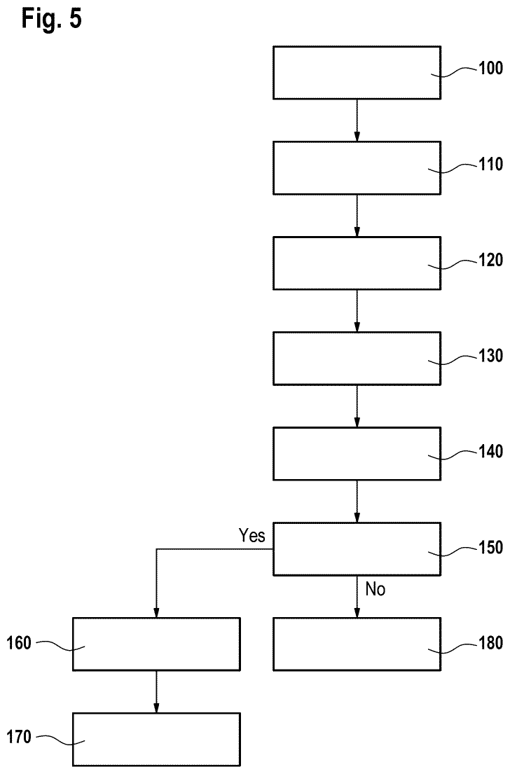

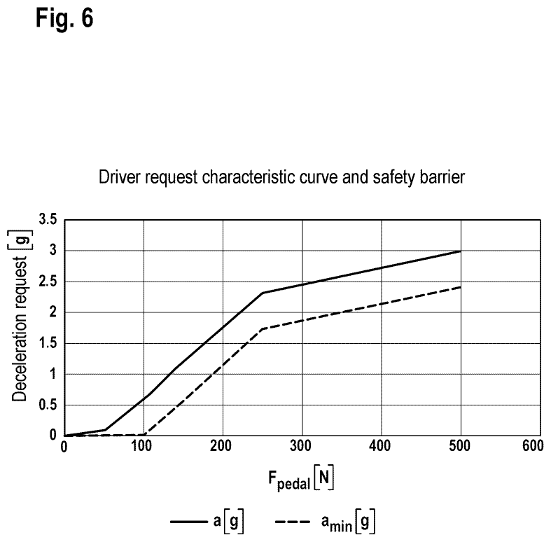

At least one brake control unit 9, 10 is configured to check the control information for the electromechanical wheel brakes 5, 6, 7, 8 that is received from the vehicle regulator 11 before forwarding and to overwrite it when a safety threshold is undershot. This will now be described in the context of the method on the basis of FIGS. 5 and 6.

FIG. 5 shows a flowchart of the method. First, there is a step 100 of transmitting pedal sensor data, which are indicative of a pedal actuation of the brake pedal 2, from pedal sensors 3, 4 to at least one of the brake control units 9, 10. Thereafter, a step 110 of calculating preprocessing data by means of at least one of the brake control units 9, 10 is performed. In a step 120, the preprocessing data are transmitted by at least one of the brake control units 9, 10 to the vehicle regulator 11 via a signal connection 12, 13, 14. Step 130 comprises calculating control information for four electromechanical wheel brakes 5, 6, 7, 8 from the preprocessing data in the vehicle regulator 11. In step 140, the control information for all electromechanical wheel brakes 5, 6, 7, 8 is transmitted to at least one brake control unit 9, 10 (that is to say not directly to the electromechanical wheel brakes 5, 6, 7, 8). Step 150 comprises determining, by means of at least one brake control unit 9, 10, before forwarding to the electromechanical wheel brakes 5, 6, 7, 8, whether the control information received from the vehicle regulator 11 undershoots a safety threshold, and if so, the control information is overwritten in step 160 before being forwarded to the electromechanical wheel brakes 5, 6, 7, 8 in step 170. If it is determined in step 150 that the control information received from the vehicle regulator 11 does not undershoot the safety threshold (“no” in the flowchart), the control information received from the vehicle regulator 11 is forwarded without change to the electromechanical wheel brakes 5, 6, 7, 8 in step 180.

The brake control units 9, 10 can automatically calculate secondary control information from the pedal sensor data and can use it to overwrite the control information received from the vehicle regulator 11 if the safety threshold is undershot. Thus, the brake control units 9, 10 can react more quickly if the control information from the vehicle regulator 11 undershoots the safety threshold, since the secondary control information can already be calculated in parallel with the vehicle regulator 11 and can be present immediately without requiring further local calculation steps. The secondary control information is thus calculated for example in parallel with one or more of steps 110, 120, 130 or 140 by at least one brake control unit 9, 10.

The safety threshold can be defined by a characteristic curve dependent on the pedal sensor data, as illustrated by way of example in FIG. 6. The characteristic curve can be stored locally in the at least one brake control unit 9, 10. The safety threshold aₘᵢₙ can be determined on the basis of a pedal-sensor-data-dependent, for example pedal-force-dependent, deceleration characteristic curve. A pedal-force-dependent deceleration characteristic curve a (solid line) is plotted by way of example in FIG. 6. The deceleration request (or brake request), that is to say the desired deceleration in units of standard acceleration of gravity (g=9.80665 m/s²), is plotted against the pedal force in newtons. Here, the pedal force may be a directly measured pedal force or a pedal force obtained by calculating different sensor data (force sensor and/or angle sensor and/or travel sensor). The safety threshold aₘᵢₙ (dashed line) is below the deceleration characteristic curve a by a constant deceleration value, for example between 0.4 and 0.8 (here 0.6) standard acceleration of gravity. However, the safety threshold aₘᵢₙ is always at least 0 m/s², that is to say is non-negative. This configuration ensures that the brake control unit 9, 10 does not intervene and the control information is not overwritten in the case of relatively small deviations of the control information sent from the vehicle regulator 11 to the brake control unit 9, 10 from the deceleration characteristic curve a. At the same time, however, it is ensured that the brake control unit 9, 10 always intervenes when a deceleration request has been detected from the pedal sensor data, but the vehicle regulator 11 does not implement any deceleration at all in the control information (for example on account of a software or memory error).

In addition, it is thus also possible to realize a safety threshold on the brake control units 9, 10. The safety threshold intervenes in the event of undetected faults of the vehicle regulator. To this end, each of the brake control units 9, 10 checks whether the target values sent from the vehicle regulator 11 to the electromechanical wheel brakes 5, 6, 7, 8 can bring about an overall deceleration of the vehicle that is plausible in accordance with the brake request locally calculated on the respective brake control units 9, 10. If this is not the case, the brake control units 9, 10 can match the brake request formed by the vehicle regulator 11 and thus increase the safety against the underbraking of the vehicle.

The safety threshold aₘᵢₙ to be provided redundantly on the brake control units 9, 10 can be equipped with the following features.

The safety threshold aₘᵢₙ is intended to be effective (that is to say match the deceleration request sent from the outside) if this deceleration request sent from the outside undershoots a minimum value.

This minimum value is intended to be dependent on the force exerted by the driver on the brake pedal 2. For this purpose, it is not absolutely necessary to directly measure this force. An estimation on the basis of the sensor signals from the electronic brake pedal 2, for example on the basis of the measured pedal actuation travel, and with knowledge of the force-travel characteristic of the electronic brake pedal 2, can replace the direct force measurement.

A characteristic curve a (F_{pedal}) of the deceleration request which is dependent on the measured or estimated force is stored on the brake control units 9, 10 (solid line in FIG. 6). This characteristic curve has a very flat profile in the region of low forces, and so there is good dosing of the brake effect. In the case of an ergonomically expedient force (which is significantly below the force of 500 N permitted for the design of fallback levels according to ECE R13H), the deceleration request is intended to be approximately 1 g, with the result that full braking on normal ground (dry road) can be brought about. With a further increase in the pedal force, the deceleration request is increased to 2 . . . 3 g. Although this deceleration cannot be implemented physically, it has the effect that the brake forces can be increased to such an extent that almost full braking can still be achieved even in the case of a poor condition of the wheel brakes 5, 6, 7, 8 (for example due to corrosion or fading).

The safety threshold aₘᵢₙ (F_{pedal}) (dashed lines in FIG. 6) is distinguished by the fact that the minimum value (i.e. the activation threshold of the safety threshold aₘᵢₙ) is at a constant distance below the above-described characteristic curve of the deceleration request. If this distance is referred to as aₜₒₗ, aₘᵢₙ(F_{pedal})=MAX(0, a(F_{pedal})−aₜₒₗ) thus applies. The parameter aₜₒₗ can in this case be chosen such that with the ergonomically acceptable pedal force, which leads to full braking in the case of a normal system function, a braking effect sufficient for most traffic situations is still achieved. For example, the design of the parameter can have the aim of achieving the so-called service braking effect according to ECE R13H (6.43 m/s²). The parameter aₜₒₗ can in this case be chosen such that there is robustness against incorrect activations of the safety threshold. The parameter aₜₒₗ can in this case be chosen such that in this case, it can be taken into account that the characteristic curve stored in the vehicle regulator 11 can deviate by a certain amount from the characteristic curve used to determine the safety threshold value within the context of the vehicle application. The parameter aₜₒₗ can in this case be chosen such that in this case, it can be taken into account that the vehicle regulator 11 realizes the deceleration desired by the driver to a certain extent with the drive system (for example during regenerative braking). The parameter aₜₒₗ can in this case be chosen such that in this case, it can be taken into account that in order to achieve further robustness against incorrect activations of the safety threshold in the case of short-term deviations of the externally sent driver brake request from the characteristic curve stored in the brake control units, it may be possible to additionally link the activation of the safety threshold aₘᵢₙ to a time condition.

If the safety threshold is activated, i.e. if the driver brake request sent from the outside is below the limit aₘᵢₙ (F_{pedal}), the brake control units instead implement the locally calculated driver brake request a (F_{pedal}).

It should be determined in an application-specific manner whether switching back to the driver brake request sent from the outside is intended to be carried out until: as soon as this exceeds the value of the safety threshold again or with the start of the next braking process or with the start of the next driving cycle.

In any case when activating the safety threshold, to store corresponding information in the non-volatile memory of the control units in order to support later fault analysis.

1. A brake system for a motor vehicle, comprising
a brake pedal having at least one pedal sensor for capturing a driver brake request from pedal sensor data;
four electromechanical wheel brakes;
a vehicle regulator;
at least two brake control units, wherein each brake control unit is configured to calculate preprocessing data from the pedal sensor data and to provide preprocessing date to the vehicle regulator via a signal connection, and wherein the vehicle regulator is configured to calculate control information for all electromechanical wheel brakes based on the preprocessing data and to transmit said control information to the wheel brakes via at least one signal connection; and
at least two primary wheel brake modules for arrangement on one vehicle wheel, wherein one of the electromechanical wheel brakes and one associated brake control unit are integrated;
wherein the pedal sensor is connected to both brake control units via in each case a separate brake request signal line.

2. The brake system as claimed in claim 1, wherein the brake pedal comprises at least two pedal sensors which determine two different measurement variables from: a force sensor, a travel sensor, an angle sensor, and wherein at least signals from two pedal sensors, are transmitted to each of the brake control units during operation.

3. The brake system as claimed in claim 2, wherein the brake pedal comprises at least two redundant pedal sensors which each determine the same measurement variable, and wherein signals from each of the at least two redundant pedal sensors can be transmitted to in each case one brake control unit during operation.

4. The brake system as claimed in claim 1, wherein the two primary wheel brake modules are assigned to one axle of the vehicle and at least one basic control unit is assigned to the two other electromechanical wheel brakes on the other axle of the vehicle to receive control information and to control at least one of the other electromechanical wheel brakes.

5. The brake system as claimed in claim 4, wherein the at least one basic control unit can be supplied with control information by both brake control units via separate signal lines during operation.

6. The brake system as claimed in claim 4, wherein the brake system comprises two secondary wheel brake modules each for arrangement on one vehicle wheel and in which in each case one of the other electromechanical wheel brakes and in each case one assigned basic control unit are integrated, wherein each of the basic control units is designed to receive control information and to control the assigned electromechanical wheel brake.

7. The brake system as claimed in claim 6, wherein both basic control units can be supplied with control information by both brake control units via separate signal lines during operation.

8. The brake system as claimed in claim 1, wherein the vehicle regulator is configured to transmit the control information for all electromechanical wheel brakes to the brake control units via a signal line, and wherein the brake control units are each configured to forward the control information to the four electromechanical wheel brakes.

9. The brake system as claimed in claim 8, wherein at least one brake control unit is configured to check the control information for the electromechanical wheel brakes that is received from the vehicle regulator before forwarding and to overwrite the control information when the control information is below the safety threshold.

10. A method for controlling a brake system comprising:
transmitting pedal sensor data indicative of a pedal actuation of a brake pedal, to at least one brake control unit;
calculating preprocessing data with at least one brake control unit;
transmitting the preprocessing data from the at least one brake control unit to a vehicle regulator via a signal connection;
calculating control information for electromechanical wheel brakes from the preprocessing data in the vehicle regulator;
transmitting the control information for all the electromechanical wheel brakes to the at least one brake control unit;
determining, with at least one brake control unit whether the control information received from the vehicle regulator is below a safety threshold; and
overwriting the control information, with the at least one brake control unit, before forwarding to the control information to electromechanical wheel brakes when the control information received from the vehicle regulator is below the safety threshold.

11. The method as claimed in claim 10, wherein the safety threshold is defined by a characteristic curve which is dependent on the pedal sensor data, wherein the characteristic curve is stored locally in the at least one brake control unit.

12. The method as claimed in claim 10, further comprising automatically calculating secondary control information from the pedal sensor data and using the secondary control information to overwrite the control information when the control information is below the safety threshold.

13. The method as claimed in claim 10, wherein the determining the control information received from the vehicle regulator is below a safety threshold is carried out by two brake control units.

14. The method as claimed in one of claim 13, determining the safety threshold on the basis of a pedal-force-dependent, deceleration characteristic curve, wherein the safety threshold is below the deceleration characteristic curve by a constant deceleration value.

15. The method as claimed in claim 10, further comprising overwriting of the control information when the control information is below the safety threshold until one of:
new control information from the vehicle regulator is above the safety threshold;
the end of the current braking process is determined or the start of a new braking process is determined; and
the end of the current driving cycle of the vehicle is determined or the start of a new driving cycle of the vehicle is determined.

16. The method as claimed in one of claim 10, wherein the overwriting of the control information before forwarding to the electromechanical wheel brakes takes place only when the control information received from the vehicle regulator undershoots the safety threshold for a predetermined minimum duration.
